(19) United States
(12) Patent Application Publication
(10) Pub. No.: US 2026/0097778 A1
(43) Pub. Date: Apr. 9, 2026

(54) VEHICLE DRIVE CONTROL SYSTEM WITH CHANGEABLE INPUTS

(71) Applicant: FCA US LLC, Auburn Hills, MI (US)

(72) Inventors: Zachary A Luetzen, Auburn Hills, MI (US); Travis D Bechtel, Auburn Hills, MI (US); Mark E Stout, II, Auburn Hills, MI (US)

(21) Appl. No.: 18/910,605

(22) Filed: Oct. 9, 2024

(51) Int. Cl. B60W 50/10; B60W 10/04; B60W 10/12; B60W 10/18; B60W 30/14; B60W 30/18

(52) U.S. Cl. CPC B60W 50/10; B60W 10/04; B60W 10/12; B60W 10/18; B60W 30/143; B60W 30/18127; B60W 2540/10; B60W 2540/12

(57) ABSTRACT

A vehicle drive control system includes a first input that is movable in a first direction to cause a first drive output command, and a control system. The control system is coupled to the first input, the control system including a processor and programming to enable a first mode in which the first drive output command has a first drive control function and a second mode in which the first drive output command has a second drive control function that is different than the first drive control function.

### FIELD

The present disclosure relates to a vehicle drive control with changeable inputs.

### BACKGROUND

Vehicles includes an accelerator pedal to control vehicle acceleration and a brake pedal to control a friction braking system of the vehicle. Some vehicles have a manually-shifted transmission and also include a third pedal to actuate a clutch. The function of each pedal is fixed and is not changeable in use of the vehicle. Further, only one pedal causes acceleration, one pedal causes braking and the other actuates the clutch. Different drivers or driving scenarios, for example, can benefit from different functions or arrangements of the controls for the vehicle drive systems.

### SUMMARY

In at least some implementations, a vehicle drive control system includes a first input that is movable in a first direction to cause a first drive output command, and a control system. The control system is coupled to the first input, the controller including a processor and programming to enable a first mode in which the first drive output command has a first drive control function and a second mode in which the first drive output command has a second drive control function that is different than the first drive control function.

In at least some implementations, in the first mode, the first drive output command is associated with a vehicle propulsion system, and, in the second mode, the first drive output command is associated with a vehicle braking system. In at least some implementations, in the second mode, movement of the first input actuates all or part of a primary braking system of the vehicle. In at least some implementations, in the second mode, the first input is associated with a regenerative braking system.

In at least some implementations, the control system is arranged so that a user can select the first mode or the second mode.

In at least some implementations, a second input is movable in the first direction to cause a second drive output command, wherein the controller is arranged so that the second drive output command is different in the first mode than in the second mode. In at least some implementations, in the first mode, the first input is associated with a vehicle braking system and the second input is associated with a vehicle propulsion system, and in the second mode, the first input is associated with the vehicle propulsion system and the second input is associated with the vehicle brake system. In at least some implementations, in the first mode, the first input is associated with a primary braking system and the second input is associated with a regenerative braking system, and in the second mode, the first input is associated with the regenerative braking system and the second input is associated with the primary braking system.

In at least some implementations, the first input is a foot-actuated pedal or a hand-operated component.

In at least some implementations, the first drive control function causes a change in vehicle propulsion and the second drive control function cases a change in a braking force in a vehicle braking system.

In at least some implementations, the first input is also movable in a second direction, opposite to the first direction and wherein movement of the first input in the second direction causes a second drive output command, and wherein the controller is arranged so that the second drive output command is different in the first mode than in the second mode.

In at least some implementations, in the first mode, movement of the first input actuates all brake assemblies in a primary braking system of the vehicle, and, in the second mode, movement of the first input actuates fewer than all of the brake assemblies of the primary braking system of the vehicle.

In at least some implementations, the first drive control function and the second drive control function can each be selected from a group including: a) increasing vehicle speed; b) actuating all brake assemblies of a vehicle braking system; c) actuating fewer than all brake assemblies of the vehicle braking system; and d) changing a force of a regenerative braking system.

In at least some implementations, a force feedback actuator provides a force resisting movement of the first input in the first direction, and wherein the force provided by the force feedback actuator is different in the first mode than in the second mode.

In at least some implementations, a third input is movable to cause a third drive output command, wherein the controller is arranged so that the third drive output command is different in the first mode than in the second mode.

In at least some implementations, the first drive output command, the second drive output command and the third drive output command can each be selected from a group including: a) increasing vehicle speed; b) actuating all brake assemblies of a vehicle braking system; c) actuating fewer than all brake assemblies of the vehicle braking system; d) changing a state of a differential or transfer case; and d) controlling a regenerative braking system.

In at least some implementations, in the first mode, movement of the first input actuates the propulsion system to directly drive one or more wheels, and, in the second mode, movement of the first input actuates the propulsion system to directly drive at least one wheel that is not one of the one or more wheels driven in the first mode.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic view of a vehicle;

FIG. 2 is a view of part of an interior of the vehicle;

FIG. 3 is a diagrammatic view of multiple inputs, shown as foot-actuated pedals;

FIG. 4 is a diagrammatic view of multiple inputs, shown as foot-actuated pedals; and

FIG. 5 shows a steering controller having multiple other inputs arranged to be actuated by hand.

### DETAILED DESCRIPTION

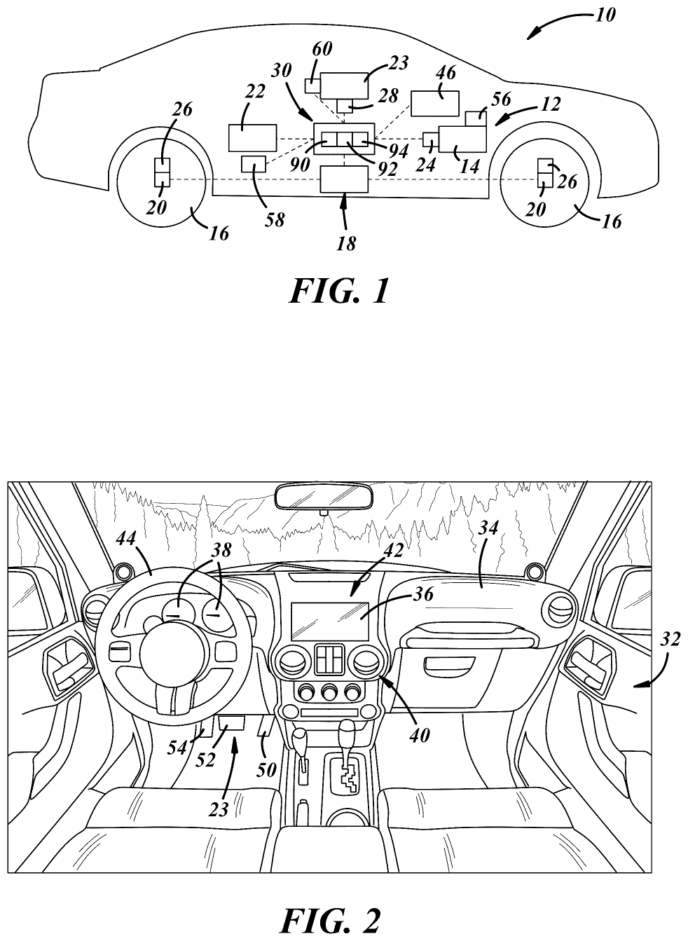

Referring in more detail to the drawings, FIG. 1 illustrates a vehicle 10 having a propulsion system 12 including a prime mover 14 coupled to multiple wheels 16 to propel the vehicle 10. The prime mover 14 could be an electric motor, a combustion engine, or both, as desired. Further, with electric motors, one or more motors may be used to power individual axles/shafts or wheels, as desired. To slow and stop the vehicle 10, the vehicle 10 includes a primary braking system 18. The primary braking system 18 includes multiple brake assemblies 20, each associated with a different one and up to each wheel 16 of the vehicle 10 includes a brake assembly 20. The brake assemblies 20 may be friction brakes of known types. Further, the vehicle 10 may include a regenerative braking system 22. When the vehicle 10 is not being accelerated, the regenerative braking system 22 can help to control and/or reduce vehicle speed, and electrical energy can be captured and stored during regenerative braking, in known manner(s).

The vehicle propulsion system 12 and the primary braking system 18 can be controlled via “by-wire” systems, commonly called “drive-by-wire” and “brake-by-wire” systems. In these “by wire” systems, there might not be mechanical connection between drive control inputs 23 (e.g. accelerator and brake inputs) and the system being controlled by actuation of the drive control inputs. Instead, in drive-by-wire and brake-by-wire systems, actuations/movements of drive controls 23 including an accelerator input and a brake input cause propulsion system actuation signals and brake system actuation signals to be sent to suitable throttle and brake actuators 24, 26 that control the vehicle propulsion and brake systems 12, 18. Suitable sensors 28 can be used to detect movement of the drive controls 23, which may include both the magnitude and rate of movement, and provide sensor output data to a control system 30. The control system 30, then actuates the throttle and brake actuators 24, 26 as a function of the sensor output received, to cause a desired propulsion or braking output of the vehicle propulsion system 12 or braking system 18. Such drive-by-wire and brake-by-wire systems and actuators are generally known.

FIG. 2 shows part of an interior 32 of the vehicle 10. A dashboard 34 includes displays 36, gauges 38, a heating and cooling system interface and outputs 40, an infotainment system interface 42, and the like. A steering wheel 44 extends from the dashboard 34 and defines a user actuated steering input. Like the propulsion and braking systems 12, 18, the vehicle steering system 46 (FIG. 1) may be controlled with a steer-by-wire arrangement in which the steering input 44 is electrically coupled to a steering actuator 48 that drives steering system components to change the direction of travel of the vehicle 10.

In this example, the drive control inputs 23 for the propulsion system 12 and braking system 18 are foot-actuated pedals, with a first input defined by a first pedal 50, a second input define by a second pedal 52 and a third input defined by a third pedal 54. Actuating each pedal 50-54 may cause a different drive control output than actuating the other pedals. In at least some implementations, the drive control outputs include, by way of non-limiting examples, propulsion/acceleration, actuating all or part of the primary braking system 18, changing a gear or mode of a transmission 56 (FIG. 1), changing the state or setting of a drivetrain component 58 (FIG. 1), changing a traction control setting (on/off or sensitivity/threshold for actuation change) and activating/deactivating the regenerative braking system 22.

In at least some implementations according to the present disclosure, the drive control function of at least one input 50, 52 or 54, and up to each of the inputs 50-54, can be changed. That is, in a first mode, actuating a changeable input causes a first drive control output and, in a second mode, actuating the changeable input causes a second drive control output that is different than the first drive control output.

To enable changing of the drive control output that results from actuation of the same input 50, 52 or 54 in the two operating modes, the control system 30 is operably associated with the input and with the vehicle systems (e.g. propulsion and braking systems 12, 18, 22, transmission 56, drivetrain component 58). The input actuation is then relayed from the control system 30 to the appropriate vehicle system or component, and this enables the same input to actuate or control different vehicle systems or functions within the vehicle systems. For example, in the first mode, the first input 50 may be associated with the vehicle propulsion system 12 and actuating the first input 50 causes an increase in vehicle speed. And, in this example and in the second mode, the first input 50 is associated with the primary braking system 18 and actuating the first input 50 applies the vehicle's friction brakes to reduce vehicle speed or stop/hold the vehicle stopped. The change in drive control function that occurs by actuation of the first input 50 is managed by the control system 30 which uses the input from the sensor(s) 28 about movement of the first input 50 and then provides the desired output.

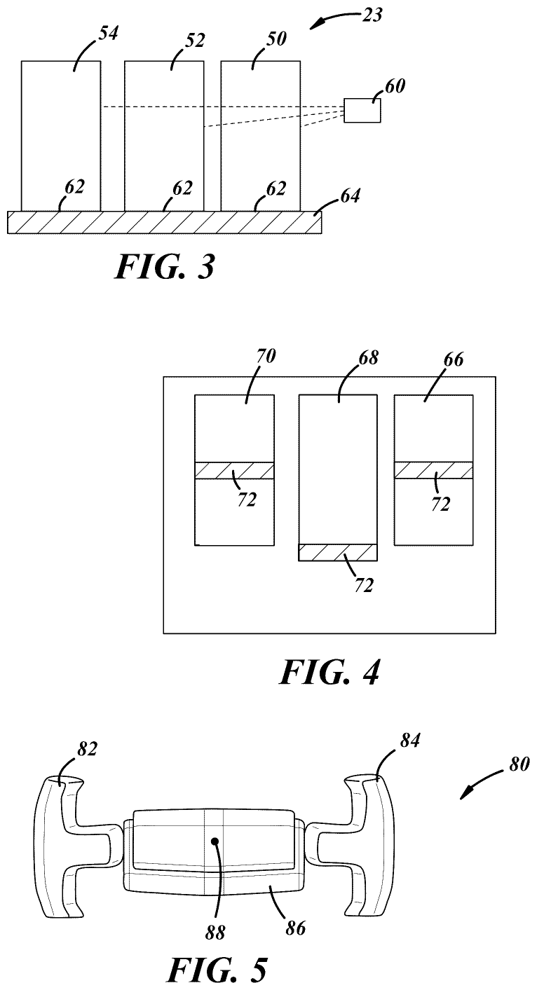

In addition to having a different output, that is, a different drive control function, the first input or first pedal 50 can have different actuating characteristics when in the different modes. For example, a force feedback actuator 60 (FIGS. 1 and 3) may be associated with an input 50 and the force needed to actuate the input 50, the amount of travel permitted during actuation of the input 50, the force feedback characteristics applied to the input 50 can change depending upon the drive control function that the input is used for. For example, the actuation, force and feel for an input used as a brake pedal can be different when the input is used as an accelerator pedal, or to turn on/off the regenerative braking system 22. Each input 50, 52, 54 may be associated with one or more actuators 60, to control actuation of the inputs as desired.

In at least some implementations, the vehicle 10 includes multiple inputs 50-54, such as pedals, that can provide different drive control functions, and the functions may be selectable by a user. In at least some implementations, user selection of the drive control function for one or more inputs 50-54 is changeable via a suitable interface 42, for example, provided by the vehicle infotainment system. In addition to or instead, a user may also connect a computer to the vehicle control system 30 to select the drive control function of one or more pedals 50-54, and more sophisticated users may be able to control various settings relating to the drive control functions and input actuation, such as the sensitivity or response of vehicle systems for a given movement of an input 50-54, a force feedback profile, and the like. The system may permit selection of the drive control function of inputs 50-54 individually, or as a group via predetermined configurations for the group (e.g. two or more inputs as a group). Group configurations can, for example, help ensure that necessary vehicle functions are accounted for and the user selections do not inhibit use of the vehicle 10 (e.g. insufficient brake inputs selected).

FIG. 3 illustrates a group of three drive control inputs 23, generically referred to as a first input 50, second input 52 and third input 54, as noted above. One and up to each of the inputs 50-54 can have a variable/selectable/changeable function, as noted herein. In this example, the three inputs 50-54 are foot-actuated pedals, each is connected to the vehicle 10 at pivots 62 near an end of the pedals and are movable in a first direction to cause a drive control output (e.g. related to acceleration or braking), and may be spring biased or otherwise biased to return in a second direction to a home or starting position after actuation. The pedals 50-54 may be mounted to the vehicle 10 in other ways for actuation such as by pushing with a foot of a driver, and need not be pivoted about an end of the pedals 50-54. The pedals 50-54 can be of different sizes and shapes and spacing, may have different travel distances, forces required to actuate, and different force feedback characteristics, as desired.

The pedals 50-54 may be connected to a base 64 that is secured within the vehicle 10 and so the pedals 50-54 and base 64 may be provided as part of a module. Different modules, including different numbers or arrangements of pedals, can be used with the vehicle 10 and may be easy to change to permit increased flexibility of use. For example, track or other performance driving pedals, in a different number or arrangement can be provided for such driving and a different module/set of pedals provided for regular, street driving.

Implementations of the inputs may include two or three pedals. In one implementation, two pedals 50, 52 are provided in a normal arrangement with one pedal controlling a vehicle braking system (regenerative braking system 22 and/or primary/friction braking system 18) and the other pedal controlling the propulsion system 12. A third pedal 54 could be used to actuate a clutch, if required. In another implementation, three pedals are used with one pedal to control the regenerative braking, another pedal to control the primary/friction braking system 18, and another pedal to control the propulsion system 12. An option is to link the friction brake control with the regenerative braking system 22 so that application of the friction brakes 20 also actuates, to some extent, the regenerative braking system 22 to provide increased braking power.

In another implementation, three pedals are used with one pedal used to control the propulsion system 12 and the other two pedals used to provide so-called “cutting brakes”, where actuation of these pedals actuates less than all of the brake assemblies 20 of the primary braking system 18. For example, one pedal may actuate the brake assemblies 20 of the front wheels 16 but not the rear wheels 16, and the other pedal may actuate the brake assemblies 20 of the rear wheels 16 but not the front wheels 16. Similar arrangements can permit separate actuation of the left side and right-side brake assemblies 20. These arrangements may be useful, for example, in different performance driving setups.

In another implementation, three pedals are used with a first pedal used to control the propulsion system 12, a second pedal used to control the primary braking system 18 and the third pedal used to control a coast function. In this example, when the first pedal is not actuated, the regenerative braking system 22 is actuated, and to stop regenerative braking, the third pedal is actuated to allow the vehicle 10 to coast without regenerative braking. The third pedal could be held down for the duration desired for coasting, or just pressed and released to turn off regenerative braking until a further input is provided (e.g. subsequent actuation of either the first or second pedal).

In another implementation, three pedals are used with one used to control the primary braking system 18 (with or without regenerative braking) and the other two pedals used to provide different throttle/acceleration/propulsion system 12 responses (e.g. different torque curves), such as throttle high and throttle low settings. These throttle settings may be used to mimic or provide low and high throttle ranges such as may be used with off-road vehicles, or when towing a trailer. This could be done through control of a mechanical transfer case 58 or simulated through software, where such software simulation is also effective for electric vehicles 10. Low throttle range operation can reduce throttle response to facilitate, for examples, navigating over larger rocks and other obstacles at lower speeds and lower torque increases.

In another implementation, pedals are used with a first pedal used to control the propulsion system 12, a second pedal used to control the primary braking system 18 and the third pedal used to control regenerative braking to reduce regenerative braking and inhibit, delay or prevent the regenerative braking from completely stopping the vehicle 10. This feature can be used, for example, to prevent regenerative braking from stopping the vehicle 10 short of an intended stop (e.g. intersection or traffic light), or to permit a vehicle 10 to move at slow speed, for example when in a traffic jam, without having to actuate the propulsion and braking systems 12, 18, or to do so less.

In another implementation, three pedals are used with a first pedal used to control the primary braking system 18, and the second and third pedals used to control selective throttle or propulsion application to specific wheels 16 of the vehicle 10, analogous to the cutting brakes described above but for propulsion. One pedal might control the right-side wheels 16 and the other the left-side wheels 16, or the split could be front and back wheels 16. The pedals could be positioned so that they may be actuated separately or at the same time with one foot, if desired.

In another implementation, three pedals are used with a first pedal used to control braking, a second pedal used to control forward vehicle propulsion and the third pedal used to control reverse vehicle propulsion. This enables reverse vehicle operation without having to shift a shift lever or the like into a reverse gear or reverse setting, and may be helpful, for example, when navigating more severe, off-road terrain when switching between forward and reverse operation more frequently may be desirable.

In another implementation, three pedals are used with a first pedal used to control braking, a second pedal to control propulsion, and the third pedal to engage vehicle drivetrain components 58 or controls, such as a differential locking mechanism, transfer case, and an amount of slip allowed at the wheels 16 (e.g. driveline clutch force).

FIG. 4 illustrates a group of three inputs, generically referred to as a first input 66, a second input 68 and a third input 70. One and up to each of the inputs can have a variable/selectable/changeable function, as noted herein. In this example, the three inputs 66-70 are foot-actuated pedals, each is connected to the vehicle 10 at pivots 72. The pedals 66, 70 and are movable in at least a first direction to cause a drive control output (e.g. related to acceleration or braking). In this example, the first and third pedals 66 and 70 are mounted for actuation in two directions (as opposed to actuation in a first direction with return in the second direction) by rotation in two directions about pivots 72 located between opposite ends of the pedals 66,70. This enables intended actuation of these pedals 66, 70 to achieve two drive control functions, which can enable additional drive controls. The drive controls can include each of those noted previously, by way of non-limiting examples. The pedals 66-70 can be of different sizes and shapes and spacing, may have different travel distances, forces required to actuate, and different force feedback characteristics, as desired. The pedals 66-70 can be part of a module for installation together into the vehicle 10, as noted previously.

In an implementation, the first pedal 66 may be actuated in a first direction (e.g. by pushing the pedal 66 at a location above the pivot 72) to provide forward propulsion of one or both wheels 16 on the left side of the vehicle 10, and in the second direction (e.g. by pushing the pedal 66 at a location below the pivot 72) to provide reverse propulsion of that or those wheels 16. Similarly, the third pedal 70 may be actuated in a first direction to provide forward propulsion of one or both wheels 16 on the right side of the vehicle 10, and in the second direction to provide reverse propulsion of that or those wheels 16. One or more wheels 16 may be driven by a separate motor, for example, in an electric vehicle 10 that has more than one traction/drive motor. The second pedal 68 may be associated with the vehicle braking system. In another implementation, two pedals (e.g. 68 and 70) are used with a first pedal 68 associated with the vehicle braking system 18 and the second pedal 70 actuated in two directions. The second pedal 70 is actuated in the first direction to actuate the vehicle propulsion system 12 and the second direction to control the regenerative braking. The regenerative braking may be applied by actuation of the second pedal in the second direction, or deactuated to permit coasting, or other regenerative function, as desired. Coasting or regenerative braking may occur when the second pedal 70 is in a neutral or home position (e.g. not actuated in either direction from a starting/home position).

FIG. 5 illustrates a hand-operated drive control device 80, which may be used as one or more of a steering input, braking input and propulsion input, and other functions as desired (e.g. may include controls for other vehicle systems, the infotainment system, etc). In the example shown, two hand-operated components, shown as paddles 82, 84, are movable/pivotable relative to a main body 86. The entire device 80 can be rotated about a center axis 88 in both directions to permit steering of the vehicle 10. In one implementation, the first paddle 82 can be pivoted in one direction (e.g. into the page as shown in FIG. 5) to control the propulsion system 12 and the second paddle 84 can be pivoted in one direction (e.g. into the page of FIG. 5) to control the braking system 18. Or, for example, the first paddle 82 can be pushed forward (e.g. into the page of FIG. 5) to control the propulsion system 12 and pulled in the opposite direction (e.g. in a direction extending out of the page of FIG. 5) to control the primary braking system 18. The second paddle 84 can be used to control regenerative braking by movement in one or both directions, as desired. Of course, hand-actuated inputs can be other than the paddles 82, 84, and could be levers, sliding mechanisms, rotary dials, or otherwise, as desired. Like the foot-actuated inputs, the vehicle system or drive control function associated with one or more hand-actuated inputs can be changed, to provide different modes of operation for the one or more hand-actuated inputs.

The hand-actuated inputs can be combined with one or more foot-actuated inputs to provide further versatility and options for vehicle control. The foot-actuated pedals could perform the drive control functions noted above with regard to the various options set forth in reference to FIGS. 1-4.

In order to perform the functions and desired processing set forth herein, as well as the computations therefore, as shown in FIG. 1, the control system 30 may include, but is not limited to, one or more controller(s), processor(s), computer(s) (generally referred to at 90), DSP(s), memory 92, storage, register(s), timing, interrupt(s), communication interface(s), and input/output signal interfaces, and the like, as well as combinations comprising at least one of the foregoing. For example, the control system 30 may include input signal processing and filtering to enable accurate sampling and conversion or acquisitions of such signals from communications interfaces and sensors. As used herein the term control system 30 or controller may refer to one or more processing circuits such as an application specific integrated circuit (ASIC), an electronic circuit, a processor (shared, dedicated, or group) and memory that executes one or more software or firmware programs 94, a combinational logic circuit, and/or other suitable components that provide the described functionality. The control system 30 may be distributed among different vehicle modules, such as a brake controller, an infotainment control module, engine control module or unit, powertrain control module, transmission control module, and the like, if desired.

The term “memory” or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system and/or instructions executable by a processor or controller or the like to enable control or allocate resources of a computing device.

Enabling different drive control functions from one or more inputs increases the versatility of the vehicle 10 and can facilitate different uses of the vehicle 10, among other things. Further, different arrangements of inputs may be provided, and this can conveniently be done with modular input units that can be removable installed in the vehicle 10. Programming can enable an interface by which the drive control function of an input can be changed, and the programming can ensure that at least some needed drive control functions are assigned to at least one input.

High-performance driving such as road course, drifting, drag, low/high speed off-road exhibition and racing, by way of some examples, can benefit from different control methods, giving more precise vehicle control to an experienced driver. The possibility of individual wheel motors that can accelerate/decelerate (up to high mu skid torque levels) with precise individual control, combined with by-wire system control enables the implementation of new control methods optimized to the driver's preferences, skill and the type of driving event. Adding feedback motors to the inputs can improve the performance of the vehicle and improve user satisfaction as it gives the driver more control of the vehicle. Since the drive inputs are not definitely assigned or fixed, vehicle updates could increase the options for which the drive inputs could be configured.

What is claimed is:

1. A vehicle drive control system, comprising:
a first input that is movable in a first direction to cause a first drive output command; and
a control system coupled to the first input, the control system including a processor and programming to enable a first mode in which the first drive output command has a first drive control function and a second mode in which the first drive output command has a second drive control function that is different than the first drive control function.

2. The system of claim 1 wherein, in the first mode, the first drive output command is associated with a vehicle propulsion system, and, in the second mode, the first drive output command is associated with a vehicle braking system.

3. The system of claim 1 wherein the control system is arranged so that a user can select the first mode or the second mode.

4. The system of claim 2 wherein, in the second mode, movement of the first input actuates all or part of a primary braking system of the vehicle.

5. The system of claim 2 wherein, in the second mode, the first input is associated with a regenerative braking system.

6. The system of claim 1 which also includes a second input that is movable in the first direction to cause a second drive output command, wherein the control system is arranged so that the second drive output command is different in the first mode than in the second mode.

7. The system of claim 6 wherein, in the first mode, the first input is associated with a vehicle braking system and the second input is associated with a vehicle propulsion system, and in the second mode, the first input is associated with the vehicle propulsion system and the second input is associated with the vehicle brake system.

8. The system of claim 6 wherein, in the first mode, the first input is associated with a primary braking system and the second input is associated with a regenerative braking system, and in the second mode, the first input is associated with the regenerative braking system and the second input is associated with the primary braking system.

9. The system of claim 1 wherein the first input is a foot-actuated pedal or a hand-operated component.

10. The system of claim 1 wherein the first drive control function causes a change in vehicle propulsion and the second drive control function cases a change in a braking force in a vehicle braking system.

11. The system of claim 1 wherein the first input is also movable in a second direction, opposite to the first direction and wherein movement of the first input in the second direction causes a second drive output command, and wherein the control system is arranged so that the second drive output command is different in the first mode than in the second mode.

12. The system of claim 1 wherein, in the first mode, movement of the first input actuates all brake assemblies in a primary braking system of the vehicle, and, in the second mode, movement of the first input actuates fewer than all of the brake assemblies of the primary braking system of the vehicle.

13. The system of claim 1 wherein the first drive control function and the second drive control function can each be selected from a group including: a) increasing vehicle speed; b) actuating all brake assemblies of a vehicle braking system; c) actuating fewer than all brake assemblies of the vehicle braking system; and d) changing a force of a regenerative braking system.

14. The system of claim 1 which also includes a force feedback actuator that provides a force resisting movement of the first input in the first direction, and wherein the force provided by the force feedback actuator is different in the first mode than in the second mode.

15. The system of claim 1 which also includes a third input movable to cause a third drive output command, wherein the control system is arranged so that the third drive output command is different in the first mode than in the second mode.

16. The system of claim 15 wherein the first drive output command, the second drive output command and the third drive output command can each be selected from a group including: a) increasing vehicle speed; b) actuating all brake assemblies of a vehicle braking system; c) actuating fewer than all brake assemblies of the vehicle braking system; d) changing a state of a differential or transfer case; and d) controlling a regenerative braking system.

17. The system of claim 1 wherein, in the first mode, movement of the first input actuates the propulsion system to directly drive one or more wheels, and, in the second mode, movement of the first input actuates the propulsion system to directly drive at least one wheel that is not one of the one or more wheels driven in the first mode.
